(19) United States
(12) Patent Application Publication
(10) Pub. No.: US 2016/0220957 A1
(43) Pub. Date: Aug. 4, 2016

(54) SEAWATER DESALINATION SYSTEM

(71) Applicant: EBARA CORPORATION, Ohta-ku Tokyo (JP)

(72) Inventors: Akira Goto, Tokyo (JP); Shigeo Takita, Tokyo (JP); Tamami Takahashi, Tokyo (JP)

(21) Appl. No.: 15/021,148

(22) PCT Filed: Sep. 11, 2014
(86) PCT No.: PCT/JP2014/074021

§ 371 Date: Mar. 10, 2016

(30) Foreign Application Priority Data
Sep. 11, 2013 (JP) 2013-187942

(51) Int. Cl. B01D 61/12; C02F 1/44; B01D 61/08; C02F 1/00; B01D 61/02; B01D 61/06

(52) U.S. Cl. CPC B01D 61/12; B01D 61/025; B01D 61/06; B01D 61/08; C02F 1/008; C02F 1/441; C02F 2209/40; C02F 2303/10

(57) ABSTRACT

A seawater desalination system uses a reverse osmosis separation device. According to characteristics of a reverse osmosis membrane, the pressure or flow change rate of seawater is controlled with respect to the membrane at the start and stop of a high-pressure pump. A drive power source control device including a parallel circuit of a reduced voltage starter and a switch is connected between an electric motor for driving the pump and an AC power source. Control of the starter causes an AC voltage supplied to the motor to increase continuously during a start-up adjustment duration to asymptotically approach an AC power source voltage from zero with an upwardly-convex monotonically-increasing function, and to decrease continuously to zero during a stop adjustment duration as far as zero. The switch is closed to supply the AC voltage of the power source directly to the motor when it equals voltage supplied via the starter.

### TECHNICAL FIELD

The present invention relates to a seawater desalination system (or plant) for carrying out desalination of seawater so that freshwater is produced from the seawater.

### BACKGROUND ART

As a prior-art seawater desalination system, a system that desalinates seawater by supplying the seawater to a reverse osmosis (RO) membrane separation system to force the seawater to pass through the RO membrane separation device, has been known. FIG. 1 shows a schematic diagram of a system circuit of such a prior-art seawater desalination system for producing freshwater from seawater. In the seawater desalination system, after seawater is taken and processed by a preprocessing apparatus 1 to satisfy predetermined water quality conditions, the seawater is supplied by a feed pump 2, via a seawater supplying line, to a high pressure pump 4 to which an electric motor 3 is directly coupled. The seawater pressurized by the high pressure pump 4 is pumped into an RO membrane separation apparatus 5 comprising an RO membrane. In the RO membrane separation apparatus 5, since the pressure applied to the seawater exceeds the osmotic pressure of the RO membrane, a part of the pressurized seawater passes through the RO membrane. As a result, water without salt or water with a reduced amount of salt is produced as freshwater 6 from the RO membrane separation apparatus 5. The remaining saltwater that is condensed and thus has a high salt concentration, is taken out of the RO membrane separation apparatus 5 as highly-pressurized condensed seawater (or brine) 7.

The highly-pressurized condensed seawater (or brine) 7 still has a high pressure, and it is guided to an energy recovery apparatus 8, where seawater has been supplied in advance from a branch of a discharging line from the feed pump 2. In the energy recovery apparatus 8, the pressure of the seawater is raised by use of high pressure of the highly pressurized condensed seawater 7.

Then, the seawater highly-pressurized by the energy recovery apparatus 8 and discharged therefrom is further pressurized by a booster pump 9 for raising the pressure of the seawater to make it to be substantially the same as the discharging pressure of the high pressure pump 4. Thereafter, the seawater from the booster pump 9 is merged to the highly pressurized seawater from the high pressure pump 4, and the resultant flow of seawater is supplied to the RO membrane separation apparatus 5.

In the seawater desalination plant, it is necessary to deal with effect affecting the RO membrane by rapid change in the pressure and/or the flow rate due to starting and/or stopping of the high pressure pump 4, and/or due to variation in temperature of the seawater, variation in the freshwater producing rate of the RO membrane relating to change of performance of the RO membrane due to aging thereof, and so on. Therefore, a rotational speed of the electric motor 3 for the high pressure pump 4 is controlled by changing a frequency of AC power provided by an AC power source 100, by use of an inverter 200. By controlling the rotational speed of the electric motor 3 by use of an inverter 200, variation in the pressure and/or the flow rate of the seawater during startup and shut-down procedures of the high pressure pump 4, is made smoother, and even if the temperature of the seawater varies and/or even if the freshwater producing rate of the RO membrane varies in relation to change of performance of the RO membrane due to aging thereof, the amount of seawater supplied to the RO membrane and the pressure of the seawater are adjusted to produce a constant amount of freshwater.

In the RO membrane separation apparatus 5, approximately 40 percent of the supplied seawater is converted to freshwater, and the remaining 60 percent of the seawater is discharged as condensed seawater, for example. If it is assumed that all of the 60 percent of the seawater (condensed seawater) is supplied to the energy recovery apparatus 8 and used to raise the pressure of the seawater in the energy recovery apparatus 8, it may be considered that 60 percent of the seawater supplied to the RO membrane separation apparatus 5 is supplied from the energy recovery apparatus 8 via the booster pump 9, and 40 percent of the seawater supplied to the RO membrane separation apparatus 5 is supplied from the high pressure pump 4. 40 percent of the seawater supplied to the RO membrane separation apparatus 5 is desalinated to be freshwater.

Accordingly, the amount of freshwater obtained by the RO membrane separation apparatus 5 is approximately equal to the amount of seawater discharged from the high pressure pump 4. Therefore, for producing a larger amount of freshwater, it is necessary to increase capacity of the high pressure pump 4, and it is necessary to increase capacity of the electric motor 3 for driving the high pressure pump 4 when the capacity of the high pressure pump 4 is increased. It should be noted that in many cases, rather than having a single high pressure pump 4 for supplying all amount of saltwater to be processed in a seawater desalination plant, the seawater desalination plant has a plurality of separate systems, each of which processes several tens of thousands tons of water per day. Even in such a case, there is a demand to increase the capacity of each high pressure pump, and it is sometimes required for each electric motor of each separate system to have capacity of several hundreds kW to several thousands kW.

Further, if the capacity of the electric motor 3 is increased, it is necessary to increase capacity of the inverter 200. However, a cost of an inverter increases exponentially with respect to a cost of the electric motor 3, when the capacity of the inverter 200 exceeds a certain level. Thus, when the scale of a seawater desalination plant is enlarged to produce a larger amount of freshwater, the ratio of the cost for the inverter 200 becomes larger in the total cost for the plant comprising the RO membrane separation apparatus 5, the high pressure pump 4, and so on.

As stated above, the inverter 200 converts the frequency of the AC power provided from the AC power source 100 to supply it to the electric motor 3. Therefore, the inverter 200 comprises a frequency conversion circuit which is always operated when the electric motor 3 is operated. In addition, the inverter 200 comprises some electronic parts having shorter lifetimes than those of the pump and/or the electric motor, and thus a maintenance frequency of the inverter 200 is higher than those of other apparatuses of the seawater desalination system. Further, since the use of an inverter having large capacity is limited, and versatility of many of the electronic parts used in such an inverter is low. Accordingly, the cost for maintaining the inverter with high capacity becomes high.

Accordingly, it is highly desired to construct a control device for a power supply for driving a high pressure pump, so as to have lower frequency maintenance and a long lifetime.

On the other hand, as illustrated in FIG. 2, a seawater desalination system without any inverter, is considered. In the system in FIG. 2, an AC current having a rated frequency is supplied directly from the AC power source 100 to the high pressure pump 4, which is so-called “direct supply of power”, and an automatic valve 11 is located in the discharging line of the high pressure pump 4. Before starting up the high pressure pump 4, an open degree of the automatic valve 11 is throttled to lower the pressure of the seawater in the downstream side of the automatic valve 11, and after starting up the high pressure pump 4, the open degree of the automatic valve 11 is gradually increased under the control of a controller, to thereby decrease a rate of change in the pressure to be applied to the RO membrane.

However, in the above case, until the automatic valve 11 is fully opened, the flow of the seawater from the high pressure pump 4 is throttled by the automatic valve 11. Consequently, temperature of the seawater staying in the high pressure pump 4 gradually increases, and as a result, the pump may not be able to keep a stable operation. Further, since the automatic valve 11 must be high pressure resistant and must permit a high flow rate, a size of the automatic valve 11 becomes larger as the flow rate increases. In addition, corrosion resistant materials must be used in the parts of the automatic valve 11 that contact with the seawater. Consequently, the cost of the automatic valve 11 increases as the size thereof increases.

Still further, when carrying out the “direct supply of power” operation, the electric power consumed instantaneously at the time of a power-up operation is approximately six times larger than the rated electric power. Thus, it is necessary to construct the power system 100 to be able to supply the electric power that is six times as large as the rated electric power. These requirements, in addition to the requirements relating to the automatic valve 11, results in increasing of the space and the cost.

### SUMMARY OF INVENTION

### Technical Problem

The present invention is made for dealing with the foregoing problems of the prior-art examples. A first object of the present invention is to provide a seawater desalination system that is capable of adjusting, to a characteristic(s) of an RO membrane, a rate of change of pressure and/or a flow rate of seawater supplied to the RO membrane during start-up and shut-down operations of a high pressure pump that supplies seawater to a RO membrane separation apparatus, and to prolong a lifetime of the system and stabilize the system.

A second object of the present invention is to provide a seawater desalination system that is capable of stabilizing an amount of freshwater produced by the system, irrespective of change in the desalination ratio of a RO membrane due to change in temperature of seawater, change in the performance of the RO membrane due to aging thereof, and so on.

### Solution to Problem

To achieve the first object, the invention provides a seawater desalination system for carrying out desalination of seawater to thereby produce freshwater from the seawater, the seawater desalination system comprising:

a high pressure pump adapted to raise pressure of the seawater to be desalinated;

a separation apparatus comprising an RO membrane adapted to separate the seawater provided from the high pressure pump, into freshwater having a low salt concentration and condensed seawater having a high salt concentration;

an electric motor adapted to drive the high pressure pump;

a start-up and shut-down adjusting device, coupled between the electric motor and an AC power source, adapted to continuously increase an AC voltage to be supplied to the electric motor during a start-up adjusting period of the electric motor, and continuously decrease the AC voltage to be supplied to the electric motor during a shut-down adjusting period of the electric motor; and

a switching circuit coupled in parallel with the start-up and shut-down adjusting device, adapted to be closed when the AC voltage to be supplied via the start-up and shut-down adjusting device to the electric motor is equal to the AC voltage outputted from the AC power source, to thereby supply the AC voltage outputted from the AC power source directly to the electric motor.

In an embodiment of the seawater desalination system of the invention, the start-up and shut-down adjusting device is adapted to increase the AC voltage to be supplied to the electric motor in accordance with a monotonically increasing function having an upward convex shape but not a linear shape during the start-up adjusting period, and decreases the AC voltage to be supplied to the electric motor in accordance with a monotonically decreasing function having an upward convex shape but not a linear shape during the shut-down adjusting period. The monotonically increasing function having the upward convex shape gradually increases and approaches the AC voltage outputted from the AC power source, and the monotonically decreasing function having the upward convex shape gradually decreases and departs from the AC voltage of the AC power source. Also, a time duration of each of the start-up shut-down adjusting periods is set to be equal to or longer than a time duration determined based on a regular operating pressure and the maximum rise gradient allowable per unit time those are required for the RO membrane of the separation apparatus, and equal to or shorter than the settable maximum time duration of the start-up and shut-down adjusting device.

Further, in the seawater desalination system as above, it is preferable to comprise a feed pump placed prior to the high pressure pump, adapted to supply the seawater to the high pressure pump; a second electric motor adapted to drive the feed pump; and a controller adapted to control the second electric motor, wherein the feed pump is controlled based on a flow rate and temperature of the freshwater obtained from the separation apparatus and the pressure of the seawater at an inlet of the separation apparatus, to adjust the flow rate of seawater drained from the feed pump so that the amount of freshwater to be obtained from the separation apparatus is stabilized. Still further, in the seawater desalination system as above, it is preferable to comprise an energy recovery apparatus adapted to draw seawater branched from the seawater discharged from the feed pump, and apply pressure to the drawn seawater to thereby increase its pressure by use of highly pressurized condensed seawater discharged from the separation apparatus, and discharge the pressurized seawater from the energy recovery apparatus; an automatic valve adapted to adjust the flow rate of the seawater from the feed pump to the energy recovery apparatus, or the flow rate of the condensed seawater from the energy recovery apparatus to the outside; and a second controller adapted to control an open degree of the automatic valve based on the flow rate of seawater from the feed pump to the energy recovery apparatus and the flow rate of seawater from the energy recovery apparatus to the separation apparatus, to thereby stabilize the flow rate of seawater from the energy recovery apparatus to the separation apparatus. By the constructions described above, the second object as well as the first object can be achieved.

To achieve the second object, the invention provides a seawater desalination system for carrying out desalination of seawater to thereby produce freshwater from the seawater, the seawater desalination system comprising:

a feed pump adapted to supply seawater to be desalinated;

a high pressure pump adapted to raise pressure of the seawater provided from the feed pump;

a separation apparatus comprising an RO membrane adapted to separating the seawater provided from the high pressure pump, into freshwater having a low salt concentration and condensed seawater having a high salt concentration;

a first and second electric motors adapted to drive the feed pump and the high pressure pump, respectively;

a first controller adapted to control the first electric motor to adjust a flow rate of seawater drained from the feed pump, based on a flow rate and temperature of the freshwater drained from the separation apparatus and pressure of the seawater at an inlet of the separation apparatus, to stabilize an amount of the freshwater drained from the separation apparatus.

It is preferable that the seawater desalination system above comprises an energy recovery apparatus adapted to draw a part of the seawater from the feed pump, apply pressure to the drawn seawater to increase its pressure by use of highly pressurized condensed seawater from the separation apparatus, and discharge the pressurized seawater; an automatic valve adapted to adjust the flow rate of seawater from the feed pump to the energy recovery apparatus or the flow rate of condensed seawater from the energy recovery apparatus to the outside; and a second controller adapted to control an open degree of the automatic valve based on the flow rate of the seawater from the feed pump to the energy recovery apparatus and the flow rate of the seawater from the energy recovery apparatus to the separation apparatus, to stabilize the amount of seawater supplied from the energy recovery apparatus to the separation apparatus.

### BRIEF DESCRIPTION OF DRAWINGS

FIG. 1 is a schematic diagram illustrating a seawater desalination system according to a prior art;

FIG. 2 is a schematic diagram illustrating another seawater desalination system according to a prior art;

FIG. 3 is a schematic diagram showing a first embodiment of a seawater desalination system according to the invention;

FIG. 4 is a circuit diagram illustrating a power control circuit for controlling power for driving a high pressure pump in the seawater desalination system shown in FIG. 3;

FIG. 5 is a diagram for explaining an operation of the power control circuit shown in FIG. 4;

FIG. 6 is an explanatory graph of flow rate versus pump head, in which curves correspond to rotation speeds of a high pressure pump;

FIG. 7 is an explanatory graph of rotational speed versus pump head of a high pressure pump;

FIGS. 8(A) and (B) are graphs for explaining time versus pump head, in the case that a rotation speed of a high pressure pump is constantly increased for each constant time period;

FIG. 9(A) is a graph showing power voltage versus time, the power voltage being supplied by the power control circuit shown in FIG. 3 to start the system, and FIGS. 9(B) and (C) are graphs showing rotational speed (RPM) and the pump head of a high pressure pump, respectively, when the voltage shown in FIG. 9(A) is supplied to the high pressure pump;

FIG. 10(A) is a graph showing power voltage versus time, the power voltage being supplied by the power control circuit shown in FIG. 3 to shut-down the system, and FIGS. 10(B) and (C) are graphs showing rotational speed (RPM) and the pump head of a high pressure pump, respectively, when the voltage shown in FIG. 10(A) is supplied to the high pressure pump;

FIG. 11 is a schematic diagram showing a second embodiment of a seawater desalination system according to the invention;

FIG. 12 is a schematic diagram showing a third embodiment of a seawater desalination system of the invention;

FIG. 13 is a schematic diagram showing a fourth embodiment of a seawater desalination system according to the invention; and

FIG. 14 is a schematic diagram showing a fifth embodiment of a seawater desalination system according to the invention.

### DESCRIPTION OF EMBODIMENTS

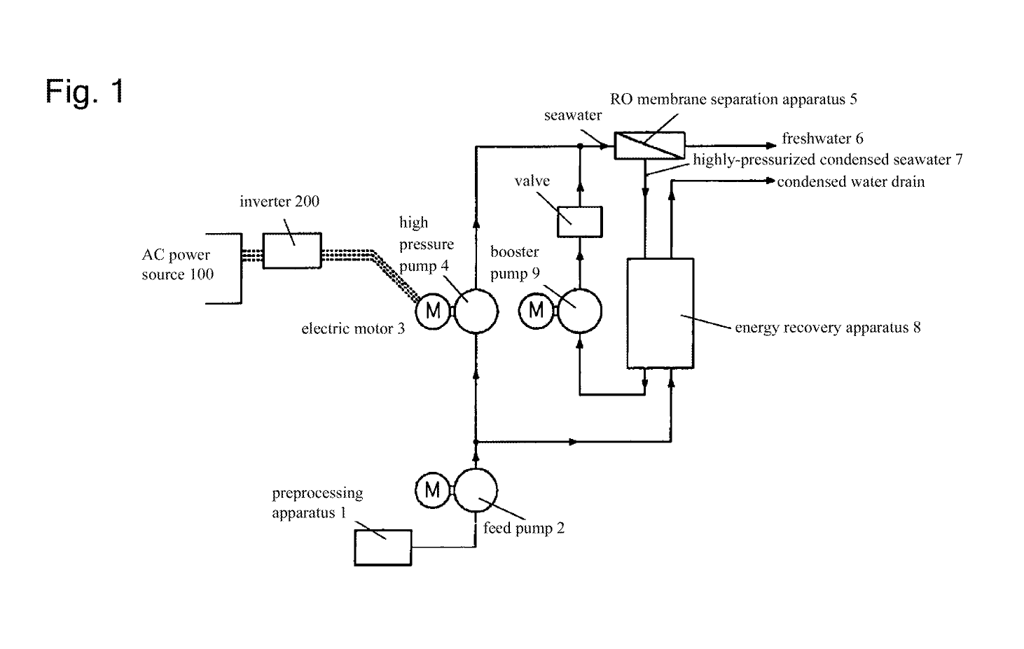

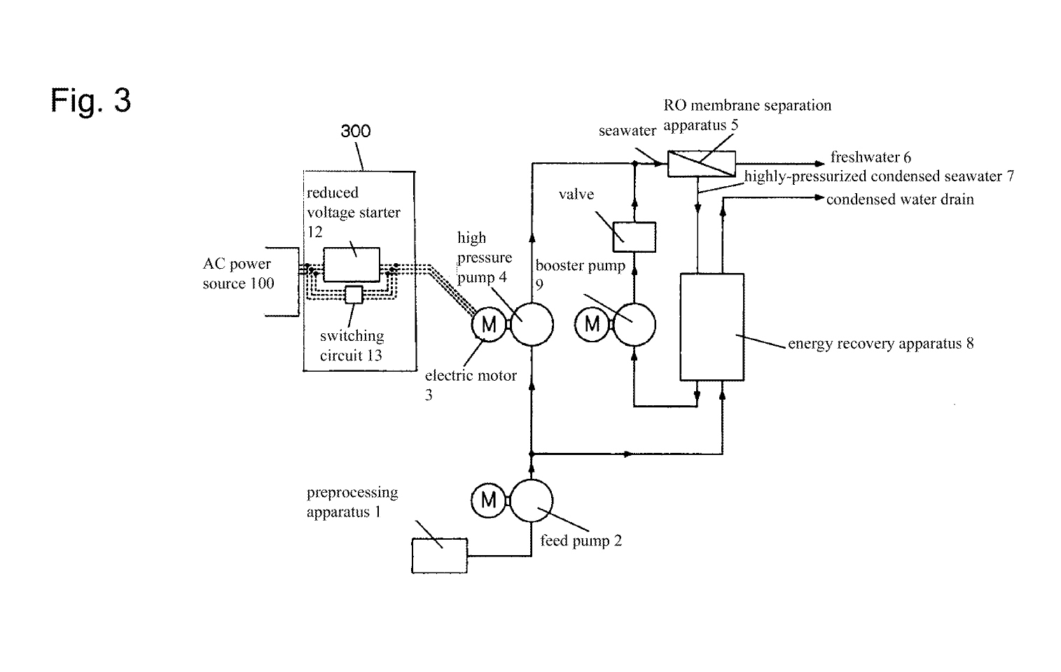

Embodiments of seawater desalination systems according to the invention and apparatuses included therein will be explained with reference to FIGS. 3-14. In FIGS. 1-14, elements identical to each other are denoted by the same reference numeral or symbol. Also, duplicated explanations for such elements will be abbreviated.

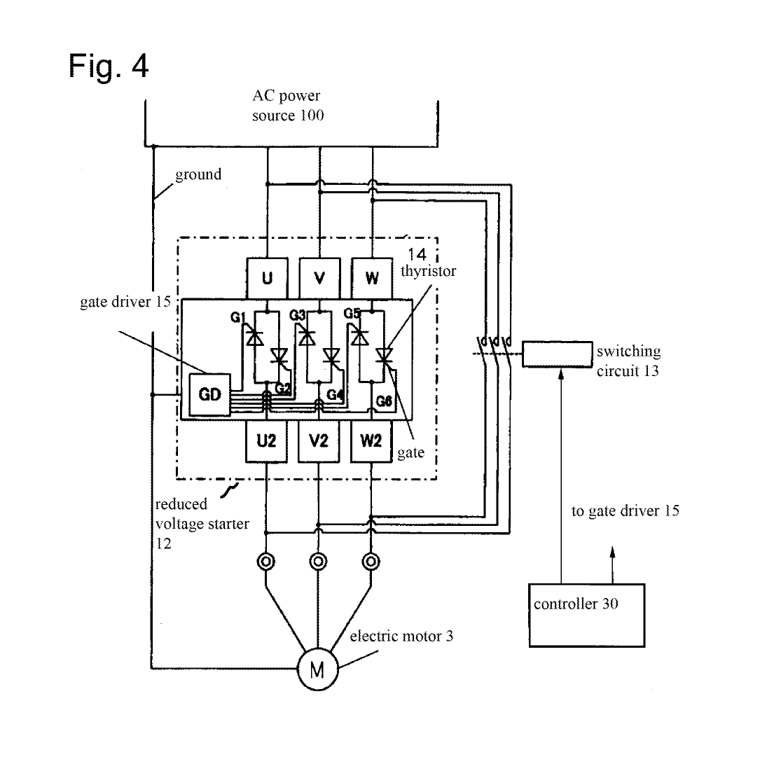

FIG. 3 is a schematic diagram illustrating a first embodiment of a seawater desalination system according to the present invention. The seawater desalination system of the invention is different from the prior-art seawater desalination system shown in FIG. 1 in that the system in FIG. 3 comprises a power control circuit 300 for controlling an electric motor 3 which drives a high pressure pump 4 for supplying highly pressurized seawater to a RO membrane separation apparatus, instead of the inverter 200 in the prior-art system shown in FIG. 1. The power control circuit 300 comprises a reduced voltage starter 12, and a switching circuit 13 as illustrated in FIG. 3, and a controller 30 as illustrated in FIG. 4. Power from an AC power source 100 is applied to the electric motor 3 via the power control circuit 300. As will be explained later, since the reduced voltage starter 12 is used when shutting down the electric motor 3, the reduced voltage starter 12 is a start-up and shut-down adjuster having functions to adjust voltages during start-up and shut-down periods of the electric motor 3.

In the reduced voltage starter 12, the AC power source 100 side is set to be a primary side, and the output side to the electric motor 3 is set to be a secondary side. The reduced voltage starter 12 operates to increase or decrease the AC output voltage of the secondary side in accordance with a predetermined pattern, to thereby softly start-up or softly shut-down the electric motor 3 coupled to the secondary side. The AC voltage from the AC power source 100 is set to be equal to a rated voltage of the electric motor 3.

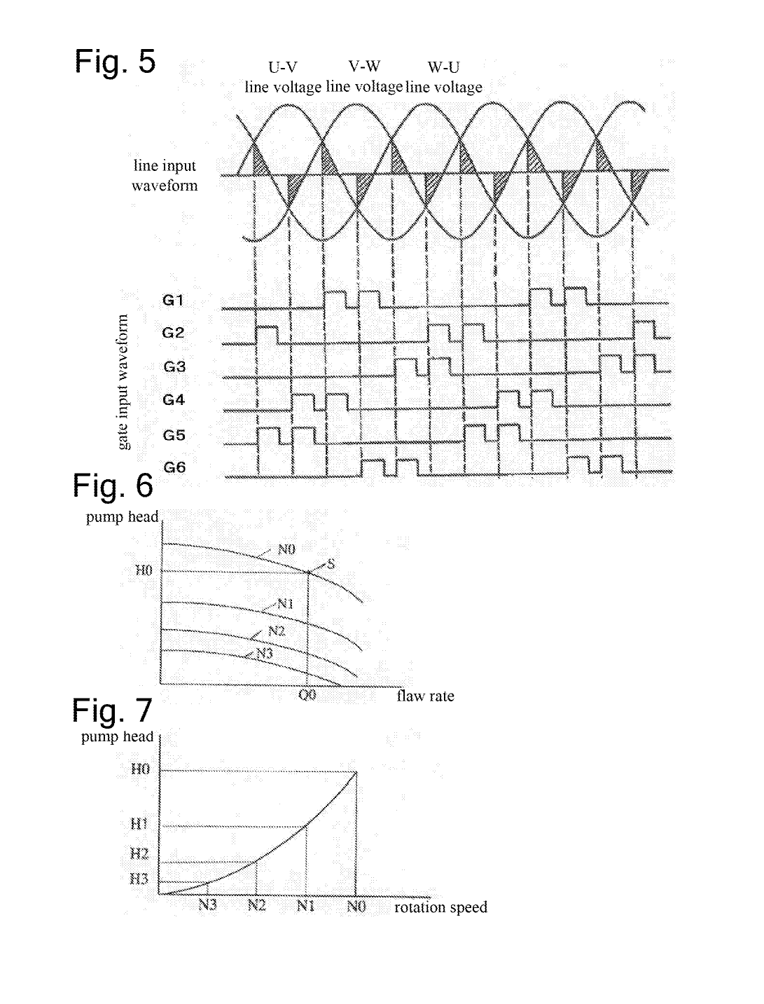

With reference to FIGS. 4 and 5, construction and operation of the power control circuit 300 will be explained in detail. As shown in FIG. 4, in the power control circuit 300, three-phase power supply lines from the AC power source 100 are connected to the primary side of the reduced voltage starter 12, while the secondary side of the reduced voltage starter 12 is coupled to the electric motor 3. The reduced voltage starter 12 comprises three circuits connected between the primary side and the secondary side, each of the three circuits comprising a pair of thyristors 14 coupled reversely in parallel with each other. The three-phase power supply lines from the AC power source 100 and three-phase power supply lines to the electric motor 3 are connected via the three circuits of the thyristors 14. The gates G1-G6 of the thyristors 14 are connected to a gate driver 15 of the reduced voltage starter 12. A controller 30 controls the gate driver 15 to supply a trigger pulse to each of the thyristors 14 and the switching circuit 13 to turn-on and off. The switching circuit 13 comprises three switches each of which is connected between the corresponding primary and secondary phase lines. The switching circuit 13 is controlled to turn off during the start-up and shut-down periods of the electric motor 3 as well as non-driving periods.

For example, by applying trigger pulses to the gates G1-G6 from the gate driver 15 as shown in FIG. 5, the thyristors 14 are turned on, and the power supply voltages (line input voltages) having sinusoidal shapes are converted to sawtooth waves as shown by the parts filled by oblique lines, and the sawtooth waves are outputted to the secondary side. By controlling the phases of the triggering pulses to the gates G1-G6, phase angle control is carried out to thereby vary the AC output voltage from the reduced voltage starter 12 in the range from zero to the maximum voltage (which is equal to the AC power supply voltage of the primary side). As a result, the AC voltage outputted from the reduced voltage starter 12 can be controlled to increase or decrease it continuously or stepwise, and by gradually increasing and decreasing the AC voltage, a device connected to the secondary side as a load, i.e., the electric motor 3 can be softly started-up and shut-down.

An increasing pattern and a decreasing pattern of the voltage provided from the reduced voltage starter 12 have been set at a controller 30, and trigger timings of the thyristors 14 have been set thereat so that the reduced voltage starter 12 outputs an AC voltage having the preset increasing or decreasing pattern. The controller 30 forwards instructions to the gate driver 15 to thereby provide the trigger pulses from the gate driver 15 to the respective thyristors 14. As a result, the predetermined increasing and decreasing patterns of the voltage can be obtained.

By the foregoing function of the reduced voltage starter 12, when starting up the electric motor 3, the AC output voltage on the secondary side thereof is gradually increased, and thus the increased voltage is supplied from the reduced voltage starter 12 to the electric motor 3 at the secondary side until the supplied voltage becomes the same as the voltage on the primary side of the reduced voltage starter 12. When the AC output voltage on the secondary side becomes the same as the supply voltage on the primary side (i.e., when the voltage reached the maximum voltage), which is accomplished by supplying the trigger pulses from the gate driver 15 to the thyristors 14 at the zero crossing points of the AC voltage on the primary side, the controller 30 controls the switching circuit 13 to turn on, and controls the gate driver 15 to terminate generation of the triggering pulses. As a result, supplying of the power via the reduced voltage starter 12 is stopped, and the AC voltage from the AC power source 100 is directly supplied to the electric motor 3 via the switching circuit 13. It may be possible that the controller 30 monitors the voltage on the secondary side of the reduced voltage starter 12, and controls the switch 13 in accordance the monitored voltage, as necessary.

On the other hand, when stopping the electric motor 3, the controller 30 controls the switching circuit 13 to turn off, and controls the gate driver 15 to provide an AC voltage at the secondary side which is gradually reduced from the maximum voltage to zero.

In the prior-art seawater desalination system shown in FIG. 1, since the frequency of the power is converted by use of the inverter 200 to drive the high pressure pump, the frequency conversion circuit within the inverter is continuously operated even during a regular operation of the high pressure pump. Thus, electronic parts of the inverter are consumed and the lifetimes thereof are shortened. In the present invention, the reduced voltage starter 12 operates only during the start-up and shut-down periods of the electric motor 3 for the high pressure pump 4, and, during the regular operation of the high pressure pump 4, the voltage is supplied via the switching circuit 13 to the electric motor 3, without passing through the reduced voltage starter 12. Accordingly, the burden to the electronic parts of the starter 12 can be reduced and the lifetimes thereof can be extended.

In the reduced voltage starter 12, there is a restriction regarding the length of the start-up period that the start-up period is determined based on capacity of the electronic parts or thyristors 14 of the reduced voltage starter 12 [Condition 1]. For example, in general, a settable range of the start-up period is approximately between 0 to 90 seconds, and, at the longest, approximately 100 seconds. The length of the start-up period must be set within the above time period.

On the other hand, there are conditions that a pump head (pressure) H increases in proportion to the square of a revolution per minute (rotational speed) N of a pump [Condition 2], and that the upper limit of a rising gradient of pressure of RO membrane is set for each RO membrane individually [Condition 3].

Accordingly, in the seawater desalination system in which high pressure is supplied to seawater by use of the high pressure pump 4 and the highly pressurized seawater is supplied to the RO membrane separation apparatus 5 to carry out desalination, there is a task relating to the high pressure pump 4 that the above three conditions must be satisfied when starting up the high pressure pump 4.

In the following, Conditions 2 and 3 will be explained in more detail.

FIG. 6 is a diagram showing characteristic curves representing relationships between flow rates Q (the horizontal axis) and the pump heads (pressures) H (the vertical axis) for rotational speeds N (N0, N1, N2, N3) of the high pressure pump 4. When the shaft of the high pressure pump 4 is directly coupled to the shaft of the electric motor 3, the rotational speed N of the pump is equal to the rotational speed of the electric motor 3. In FIG. 6, the rotational speed N0 of the pump is the rated rotational speed, and N0>N1>N2>N3.

During a stable operation, the high pressure pump 4 is driven at the rated rotational speed N0, and is driven for instance at the driving point S (with the flow rate Q0 and the pump head H0) on the curve regarding N0. The flow rate Q and the pump head H for each rotational speed can be represented as follows, in which Q0 and H0 are the flow rate and the pump head at the driving point S when the pump is driven at the rated rotational speed N0:

Q=Q0*(N/N0) (1)

H=H0*(N/N0)² (2)

As represented above, the flow rate Q is proportional to the rotational speed of the pump, and the pump head H is proportional to the square of the rotational speed of the pump.

FIG. 7 illustrates a graph representing Equation (2), in which the horizontal axis represents the rotational speed N of the pump, and the vertical axis represents the pump head H. The flow rate Q is determined based on the characteristic curves shown in FIG. 6. As is obvious from FIG. 7 and Equation (2), if the rotational speed N is constantly increased, the pump head (pressure) H is increased in proportion to the square of the rotational speed N (Condition 2).

Next, Condition 3, i.e., the restriction relating to pressure condition for an RO membrane that is determined based on the characteristic of the RO membrane used in the RO membrane separation apparatus 5, will be explained. As briefly explained with regard to the prior arts, rapid change in the pressure and/or the flow rate of the seawater due to start-up and/or shut-down of the high pressure pump exerts bad influence on the RO membrane. For instance, deteriorating the performance, shortening the lifetime of the RO membrane may be caused by the rapid change. Therefore, it is necessary to gradually apply pressure to the RO membrane. As a substantive example, in a certain RO membrane, there is a restriction that the rate of increase in pressure must be equal to or less than 0.7 bar (approximately 0.07 MPa, water head of 7 meters) per second. That is, the rise gradient of the pressure per unit time must be set to be equal to or less than 0.7 bar/s. The restriction for the rise gradient is set for each RO membrane.

On the other hand, the RO membrane can stably operate at approximately 70 bar (approximately 7 MPa, water head of 700 meters). Accordingly, when raising the pressure of seawater by use of the high pressure pump 4 from the atmospheric pressure to approximately 70 bar, and when there is a restriction that the rate of increase of the pressure applied to the RO membrane must be equal to or less than 0.7 bar/s, it is required to spend 100 seconds or more, to slowly and gradually raise the pressure (pump head) of the high pressure pump.

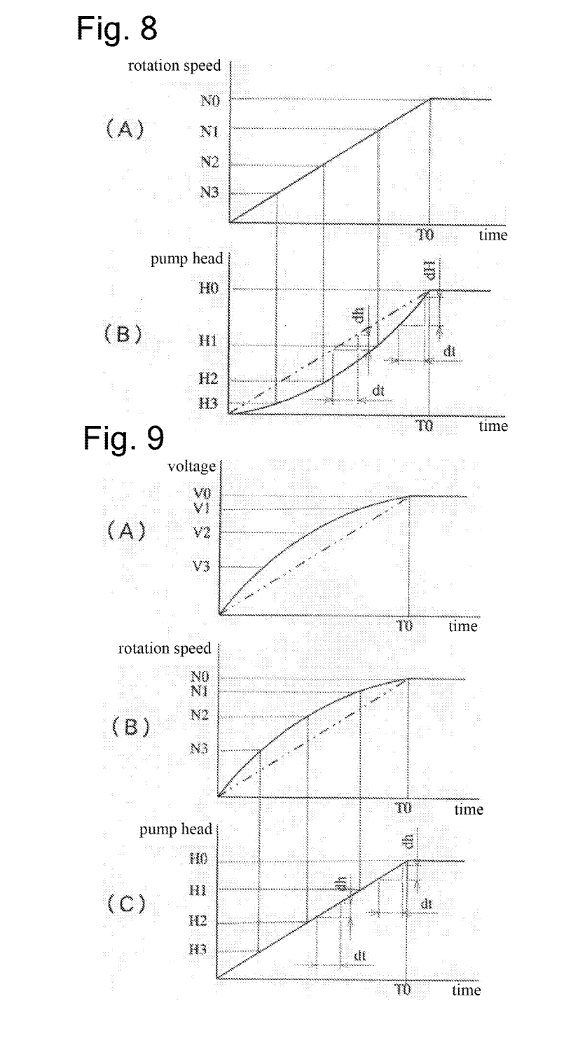

However, it is not easy to satisfy all of Conditions 1-3. A case where the Condition 3 is taken into consideration will be explained with reference to FIG. 8. In the case that the pump head during a stable driving state of the high pressure pump 4 is 70 bar, and the limit of the rate of increase of the pressure applied to the RO membrane is 0.7 bar/s, it can be understood that it is possible to spend 100 seconds for raising the pump head to 70 bar, and thus the reduced voltage starter that has the maximum setting time of 100 seconds can be selected. However, since the relationship between the pump head (pressure) H and the rotational speed N of the pump is represented by a quadratic function as illustrated in FIG. 7, if the rotational speed N is increased with a constant rate as shown in FIG. 8(A), the pump head (pressure) H increases according to a quadratic function relative to the time t. A solid line in FIG. 8(B) shows the curve of the quadratic function of the pump head when increasing the rotational speed N with the constant rate.

In FIG. 8(B), the two-dot broken line shows that the pump head increases with a constant rate dh/dt which is set to be the limit of the rate of increase of the pressure applied to the RO membrane, and the time required to raise the pressure to the pump head H0 is shown as T0. dH/dt in FIG. 8(B) is the rate of change in the pump head H represented by the quadratic function shown by the curved line. dH/dt gradually increases as the time elapsed, becomes larger than the rate defined by the required specification so that it becomes the maximum at around the point where the voltage reaches the maximum voltage.

Therefore, if the output voltage from the reduced voltage starter 12 varies with a constant change rate with respect to time, Condition 3 cannot be satisfied. Further, depending on Condition 1, i.e., the time restriction relating to a start-up period settable in the reduced voltage starter 12, there may be a case that all of the conditions cannot be satisfied.

The inventors of the present invention found more improved start-up conditions as a result of study that, regarding the relationship between the time t and the rotational speed N of the pump during the period from a time that the pump is started up to a time that the pump becomes the rated driving state. That is, the rotational speed N should be increased as an exponential function with regard to time t, N∝k*t^{α} (k is a constant), and α should be less than 1.

Specifically, in the case that an ideal situation is used as an example, since the pump head H that is a characteristic of the pump, is proportional to the square of the rotational speed N of the pump as shown in FIG. 7, it is preferable to set the rotational speed N of the pump in proportion to the time to the power of 0.5th (t^{0.5}). In this example, since the rotational speed N of the pump is linearly proportional to the voltage V supplied to the electric motor 3, if the increasing pattern of the voltage V is set to be t^{0.5}, the rotational speed N of the pump becomes in proportion to t^{0.5}. Accordingly, the reduced voltage starter 12 provides the voltage having an increasing pattern in proportional to t^{0.5}, the rate of change of the pressure dh/dt can be made to be substantially constant.

The matters described above will be explained with reference to FIG. 9. First, a reaching time period T0 from a time that the reduced voltage starter 12 starts its operation to a time that the AC voltage from the starter 12 reaches the maximum voltage V0, is determined on the basis of the rise gradient of the pressure per unit time selected based on characteristics of an apparatus and a RO membrane, and the pressure H0 during a stable driving state of the high pressure pump 4. Then, as shown in FIG. 9(A), a rising straight line (a two-dot chain line) representing a voltage increased in accordance with a constant gradient during an interval from the start-up time point to the time point T0 corresponding to the maximum voltage V0, is imagined, and the voltage is increased in accordance with the curve (solid line), that is above the rising straight line, has an upward convex shape, and gradually approaches the maximum voltage V0.

When the AC voltage V outputted from the reduced voltage starter 12 is increased in accordance with the rising curve in FIG. 9(A) drawn by the solid line, the rotational speed N of the high pressure pump with respect to the time t also increases in accordance with a curve shown in FIG. 9(B) that is substantially the same as that in FIG. 9(A), and gradually approaches the rated rotation speed N0. As a result, as shown in FIG. 9(C), the rate of increase of the pump head H becomes substantially constant.

By carrying out the above operation, the rate dh/dt of increase of the discharging pump head H can be controlled to be substantially constant. In addition, since the reaching time T0 is determined by taking the maximum rate of increase of the pressure to be applied to the RO membrane into consideration, the rate dh/dt of increase of the discharging pump head H does not exceed the maximum rate of increase. For example, in the graph in FIG. 9(A), the time T0 is set to correspond to the time point that the voltage just reached the rated voltage V0 on the two-dot chain line. However, by setting the time T0 to be T0+Δt, it is possible to set the dh/dt in FIG. 9(B) to be smaller than the maximum rate of increase of the pressure. Thus, it is possible to drive the pump with a rate of increase of the pressure that is equal to or less than the maximum rate of increase of the pressure. However, it is possible to achieve the shortest time period, by increasing the pressure using the permissible maximum rate of increase of the pressure applied to the RO membrane and a constant gradient in the control operation.

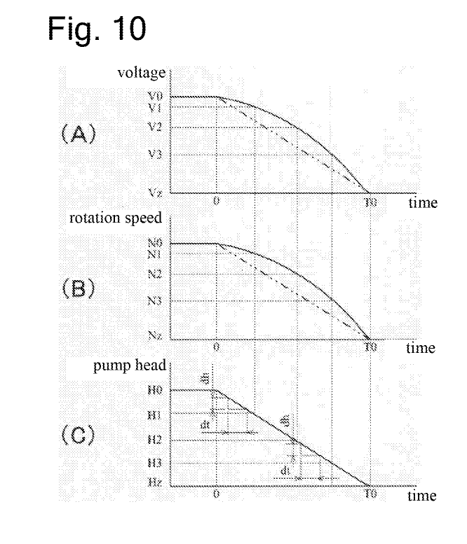

When carrying out the shut-down operation of the system, as shown in FIG. 10(A), a falling straight line (a two-dot chain line) representing a voltage decreased in accordance with a constant gradient during an interval from the starting shutting-down time point to the time point T0 corresponding to the shut-down, is imagined, and the voltage is decreased in accordance with the curve (solid line), that is above the falling straight line, has an upward convex shape, and gradually approaches the maximum voltage Vz. When the AC voltage V outputted from the reduced voltage starter 12 is decreased in accordance with the falling curve in FIG. 10(A), drawn by the solid line, the rotational speed of the high pressure pump with respect to the time t also decreased in accordance with a curve as a solid line shown in FIG. 10(B). As a result, as shown in FIG. 10(C), the rate of decrease of the pump head H becomes substantially constant. By decreasing the rotational speed of the high pressure pump 3, as shown above, the pressure during the shut-down period can be gradually decreased instead of sudden changes. As a result thereof, the fluidic devices and the RO membranes can be protected, and the plant can be safely stopped.

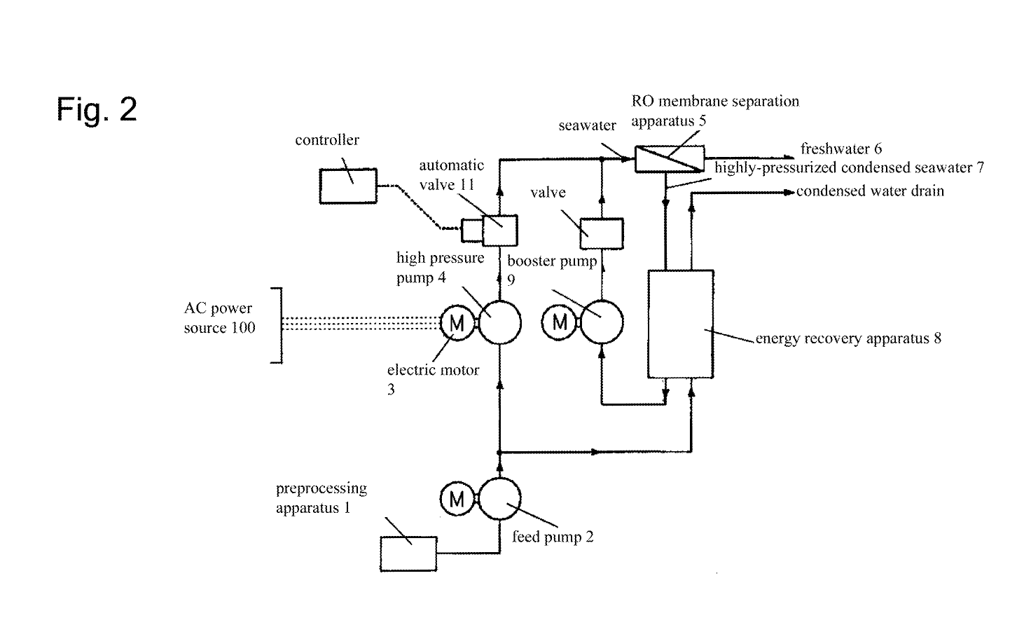

In practice, due to a mechanical loss, a hydrodynamic loss of pipe arrangement, a condition relating to an upper time limit used for the start-up operation of an apparatus (or Condition 1), and/or the maximum allowable rate of increase of the pressure set for the RO membrane (or Condition 3), the pump may not be able to be driven in accordance with the ideal state that uses an exponent of α=0.5. Even in such a case, by setting, in the start-up operation by the reduced voltage starter 12, a pattern that uses an exponent having a value less than 1 (α<1) and increases the AC voltage accordingly, rapid increase of the pressure that exerts bad influence on the RO membrane can be moderated and the lifetime of the RO membrane can be extended. Further, in contrast to the prior-art system shown in FIG. 2, a large and expensive automatic valve is not required, the temperature of the seawater staying in a high pressure pump does not rise, and the pump can be stably driven continuously.

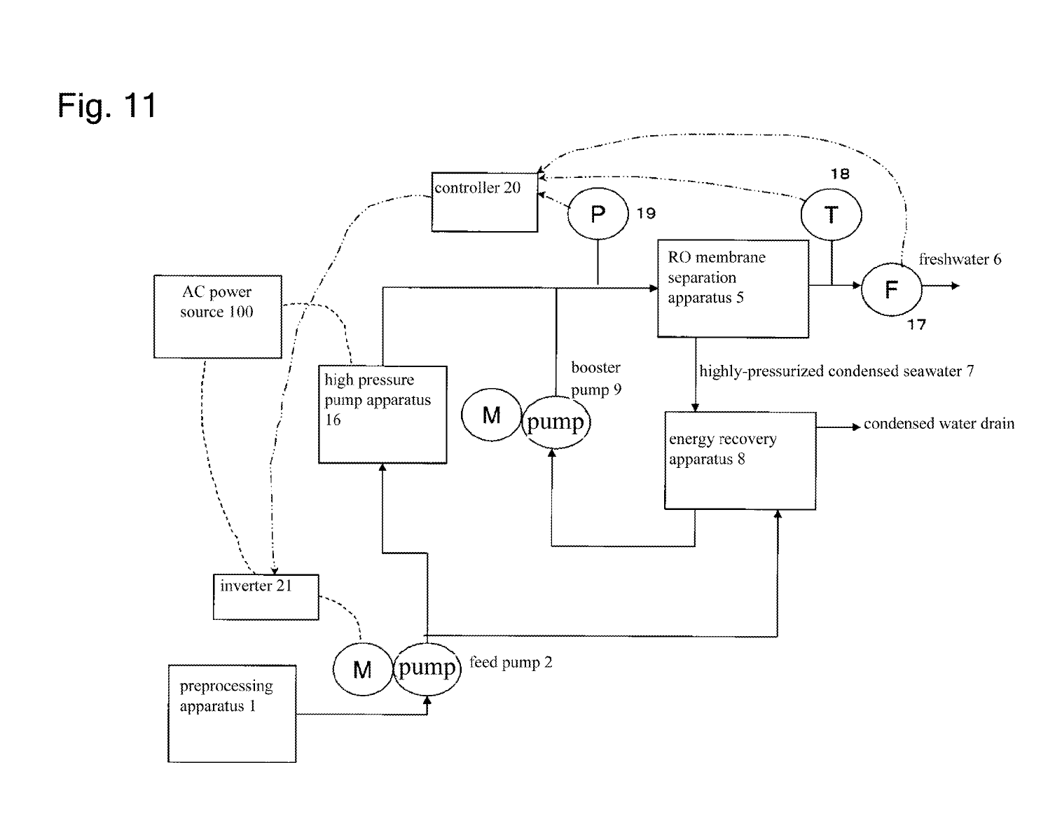

FIG. 11 is a schematic diagram showing a second embodiment of a seawater desalination system of the invention. A high pressure pump apparatus 16 comprises the high pressure pump 4 the electric motor 3 for driving the high pressure pump 4 those are illustrated in each of FIGS. 1-3, and control apparatuses for avoiding rapidly-changing pressure applied to the RO membrane during start-up and shout-down period of the high pressure pump, such as the inverter 10 shown in FIG. 1, the driving power source 300 shown in FIG. 3, the automatic valve shown in FIG. 2, and so on. The high pressure pump apparatus 16 is preferably controlled in such a manner that, after the high pressure pump 4 reaches the rated driving state under the control of the control apparatus, the switching circuit 13 is turned on to thereby drive the electric motor 3 for the high pressure pump 4 directly by the AC power from the electric power source 100. In such a case, when the pump 4 is driven in the rated driving state, the apparatus for avoiding rapidly pressure change to the RO membrane during start-up and shut-down period does not operate, when the pump is driven in the rated driving state, and thus excessive burden is not applied to the electronic parts in the control device, and the lifetimes thereof can be extended.

Next, an embodiment having an operation in an actual plant, as well as the improved operations of the high pressure pump apparatus 16 for avoiding application of rapidly pressure change to the RO membrane during start-up and shut-down periods, will be explained. In an actual plant, if the desalination ratio of a RO membrane is decreased due to change in temperature of seawater and/or change in performance of the RO membrane due to aging thereof, production of freshwater will be reduced since an amount of produced freshwater is unstable. Further, if the plant is continuously operated without dealing with the system fluctuations, apparatuses in the system are overloaded and, as a result, the apparatuses are damaged and/or the lifetimes thereof are shortened.

The seawater desalination system shown in FIG. 11 can solve the problems as above, in which an inverter 21 is connected between the power source 100 and the electric motor of the feed pump 2 to change the pressure and the flow rate of the seawater from the feed pump 2, so that the flow rate and the pump head of the seawater discharged from the high pressure pump 4 connected to the feed pump 2 in the downstream side thereof, can be changed.

Further details regarding adjustment of the flow rate and the pump head will be explained. The temperature and/or the flow rate of the seawater supplying line connected to the RO membrane separation apparatus 5, the temperature and/or the flow rate of the line for the produced water (freshwater) obtained from the RO membrane separation apparatus 5, and the pressure applied to the RO membrane are detected by sensors (or switches). That is, a flow rate sensor (or a flow rate switch) 17 for detecting the flow rate of the freshwater, a temperature sensor (or a temperature switch) 18 for detecting the temperature of the freshwater, and a pressure sensor (or a pressure switch) 19 for measuring the pressure of fluid flowing into the RO membrane separation apparatus 5, are provided. The data and/or signals obtained by the sensors are sent to a controller 20, and, based on the data and/or signals, the controller 20 generates an instruction to control the inverter 21 to change the power supplied to the electric motor of the feed pump 2 so that the pressure and flow rate of the seawater drained from the feed pump 2 are appropriated. Thus, since it becomes possible to change the suction pressure of the high pressure pump and, it becomes possible to change the flow rate and the pump head of discharge of the high pressure pump.

Regarding the sensors (or switches) for detecting the pressure, the temperature, and the flow rate shown in FIG. 11, the positions thereof are not limited to those shown in FIG. 11. That is, they can be placed anywhere as long as the pressure, the temperature, and the flow rate equivalent to those detected at the positions shown in FIG. 11 can be detected. For example, the pressure of the seawater supplying line can be detected by placing the pressure sensor (or the switch) 19 on the discharge line of the high pressure pump 4 or the booster pump 9, since the pressure of the discharge line of the high pressure pump 4 and that of the booster pump 9 are the same.

When that the temperature of seawater rises, there is a tendency that the ratio of the flow rate of the freshwater (the produced water) discharged from the RO membrane separation apparatus 5 decreases, relative to the flow rate of seawater flowing into the RO membrane separation apparatus 5. This tendency is due to a characteristic of the RO membrane relating to temperature. For dealing with the tendency, the temperature and the flow rate of freshwater obtained from the RO membrane separation apparatus 5 are detected by the temperature sensor 18 and the flow rate sensor 17, and when it is detected that the temperature of the freshwater has increased or the flow rate thereof has decreased, the electric motor for the feed pump 2 is controlled via the inverter 21 to increase the rotational speed thereof, to increase the flow rate of the seawater from the feed pump 2, resulting that the pressure of the seawater supplied from the high pressure pump apparatus 14 (the high pressure pump 4) to the RO membrane separation apparatus 5. The RO membrane has a characteristic such that the ratio for separating freshwater from seawater increases as the pressure applied thereto increases. Thus, the flow rate of the freshwater, that tends to be decreased, can be increased if the pressure of seawater supplied to the RO membrane can be increased. Accordingly, the flow rate of the produced freshwater can be kept substantially constant.

By controlling as stated above, the amount of freshwater obtained from the RO membrane separation apparatus 5 can be kept substantially constant, even if change in performance of the RO membrane due to aging thereof, in addition change in temperature of water, has occurred.

The pump head of the feed pump 2 is approximately 0.3 MPa, which is smaller than that of the high pressure pump 4. On the other hand, the flow rate of the feed pump 2 is high, since it is necessary to supply seawater to the high pressure pump 4 and the energy recovery apparatus 8. Since the discharge pressure of the feed pump 2 is smaller, the capacity of the electric motor thereof is one-several-tenth of that of the high pressure pump. Thus, in the case that the electric motor for the feed pump 2 is driven by the inverter 21, an inverter for general use having capacity of around several tens kW can be utilized as the inverter 21. Accordingly, the size of the inverter 21 can be small, and maintenance of such a small inverter is easy, and the cost for the small inverter is considerably low.

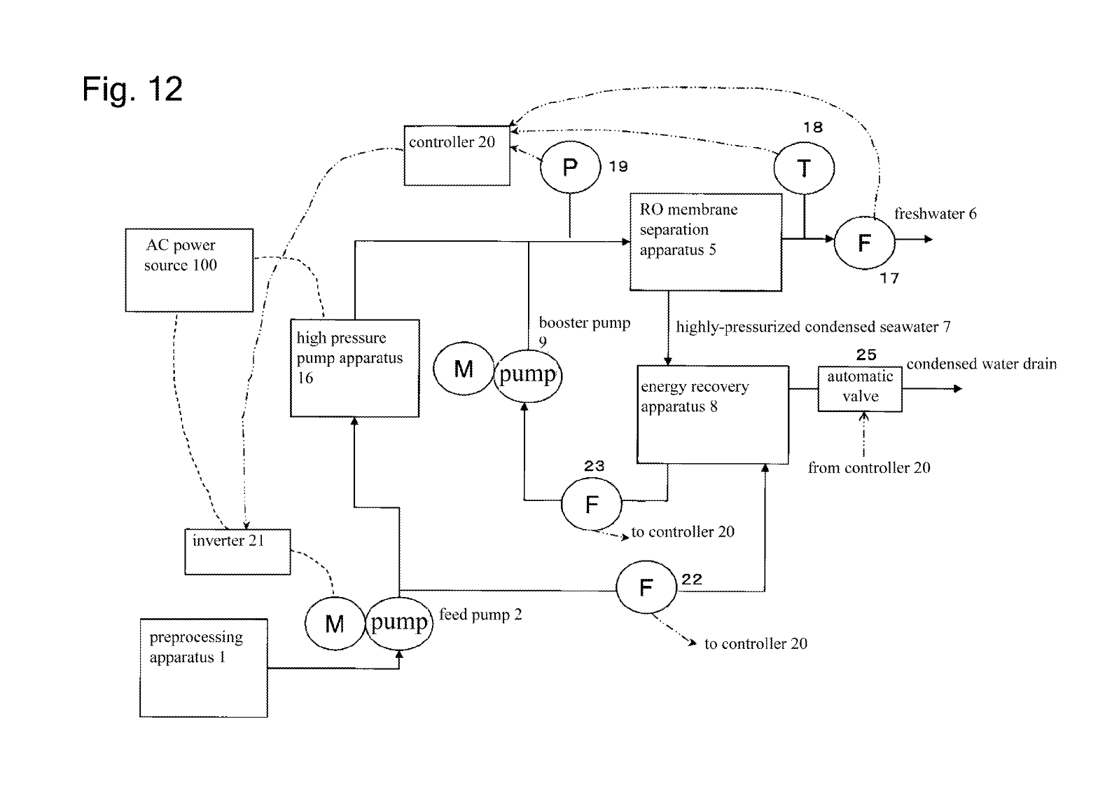

FIG. 12 is a schematic diagram showing an example of a third embodiment of a seawater desalination system according to the present invention. The third embodiment is a modified version of the second embodiment shown in FIG. 11. In the second embodiment, driving of the feed pump 2 is controlled by the inverter 21, and accordingly, the driving point, i.e., the flow rate and the pressure of the seawater from the feed pump 2 is changed by the control. Thus, the pressure and the flow rate of the seawater supplied to the energy recovery apparatus 8, which is branched from a discharging flow from the feed pump 2, is also changed.

The energy recovery apparatus 8 adds pressure to the seawater supplied from the feed pump 2 by use of the highly pressurized condensed seawater 7 from the RO membrane, and discharges the seawater. Thus, if the flow rate of seawater from the feed pump 2 changes due to controlling of the rotational speed of the feed pump 2, the amount of seawater flowing into the energy recovery apparatus 8 increases or decreases. For example, if the amount of seawater flowing into the energy recovery apparatus 8 decreases, and if the energy recovery apparatus 8 operates when seawater flowing thereto is decreased in such a manner that the amount of seawater discharged from the energy recovery apparatus 8 is the same as the amount of seawater discharged from the energy recovery apparatus 8 before the amount of seawater flowing into the energy recovery apparatus 8 decreases, the salt concentration of seawater in the energy recovery apparatus 8 is increased by the condensed seawater and seawater having high salt concentration is discharged from the energy recovery apparatus 8. Contrary, if the amount of seawater flowing into the energy recovery apparatus 8 increases, and if the energy recovery apparatus 8 operates when seawater flowing thereto is increased in such a manner that the amount of seawater discharged from the energy recovery apparatus 8 is the same as the amount of seawater discharged from the energy recovery apparatus 8 before the amount of seawater flowing into the energy recovery apparatus 8 increases, the energy recovery apparatus 8 does not discharge the increased amount of seawater, although extra amount of seawater is drawn to the apparatus. In the former case, since the salt concentration of the seawater supplied to the RO membrane becomes high, production of freshwater decreases. In the latter case, since the preprocessed seawater is wasted, the cost for preprocessing relative to the amount of produced freshwater increases.

For dealing with the above problems, a flow rate sensor 22 is provided on the seawater drawing line, a flow rate sensor 23 is provided on the seawater discharging line, and an automatic valve 25 is provided on the condensed water draining line of the energy recovery apparatus 8, as shown in FIG. 12. Based on the flow rates of the drawn seawater and the discharged seawater detected by the flow rate sensors 22 and 23, the controller 20 controls the automatic valve 25 on the condensed water draining line for changing the flow resistance of the automatic valve 25 to thereby adjust the flow rate of the condensed water to be drained. Thus, it becomes possible that the flow rate of seawater drawn from the feed pump 2 to the energy recovery apparatus 8 is adjusted based on the output from the flow rate sensor 23 placed on the seawater discharging line. As a result, the flow rate of seawater that is fed back from the energy recovery apparatus 8 to the RO membrane separation apparatus 5 can be controlled to keep it to be substantially constant.

Although the automatic valve 25 is provided on the condensed water draining line in the embodiment in FIG. 12, it can be placed on the seawater drawing line that is branched from the seawater discharging line from the feed pump to the energy recovery apparatus 8. By use of the above construction, it becomes possible that the flow rate of the seawater drawn to the energy recovery apparatus 8 can be adjusted at the upstream side of the energy recovery apparatus 8 based on the output of the flow rate sensor 23 on the discharging line from the energy recovery apparatus 8. Regardless of whether the automatic valve 25 is placed on the seawater drawing line to the energy recovery apparatus 8 or the condensed water draining line from the energy recovery apparatus 8, the flow rate of drawing of seawater to the energy recovery apparatus 8 can be adjusted, and the flow rate of the seawater from the energy recovery apparatus 8 to the RO membrane separation apparatus 5 can be stabilized. By providing the side of the energy recovery apparatus 8 with the functions to control the flow rates of the drawn seawater and the discharged seawater in the manner explained above, the amount of seawater to be drawn to the energy recovery apparatus 8 and the amount of condensed water to be supplied to and drained from the energy recovery apparatus 8 are automatically adjusted, even when the pressure and the flow rate of seawater draine4d from the feed pump 2 are changed by controlling the rotational speed of the feed pump 2. Thus, it becomes possible to reduce a loss of preprocessed seawater, and reduce the cost accordingly.

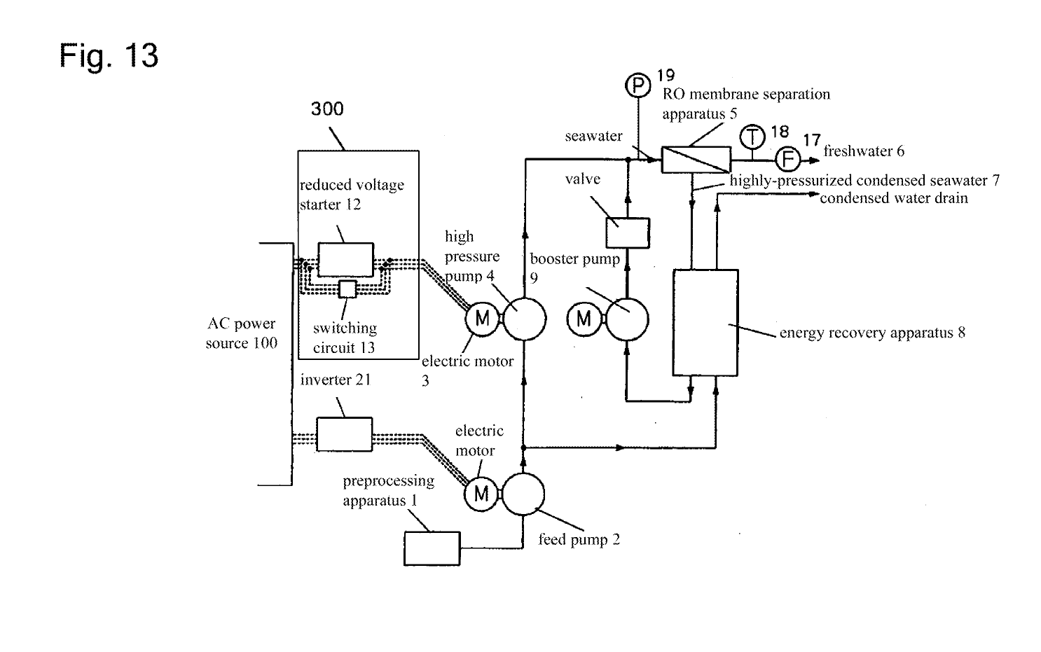

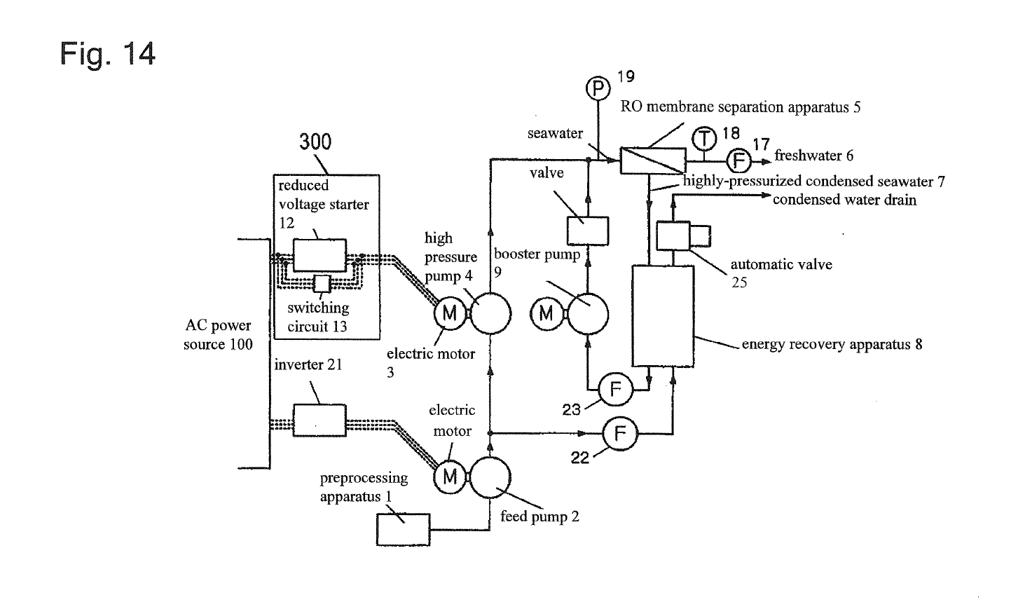

FIGS. 13 and 14 show embodiments those are constructed based on those shown in FIGS. 11 and 12, respectively. In each of the embodiments shown in FIGS. 13 and 14, the reduced voltage starter 12 and the switching circuit 13 shown in FIG. 3 are used in the high pressure pump apparatus 16 for avoiding application of rapidly changing pressure to the RO membrane during the start-up and shut-down periods of the pump 4. In these drawings, controllers or the like for controlling the inverter 21 and the automatic valve 25 are not illustrated. In each of the seawater desalination systems shown in FIGS. 13 and 14, it is possible to extend the lifetime of the system and drive the system stably even if the capacity of the high pressure pump is enlarged, it is possible to adjust, based on a characteristic(s) of the RO membrane, the rate of change of the pressure and/or the rate of change of the flow rate of seawater supplied to the RO membrane during start-up and shut-down periods of the high pressure pump, and it is possible to keep production of freshwater substantially constant, regardless of change in the desalination ratio of the RO membrane due to change in the temperature of seawater and/or change in the performance of the RO membrane due to aging thereof.

The above embodiments are described for the purpose of making a person having an ordinary skill in the related art to be able to practice the present invention. Various modifications of the above embodiments can be made by a person skill in the art; and the technical ideas of the present invention are applicable to other embodiments. Thus, the present invention is not limited to the described embodiments, and the present invention must be interpreted that it has the widest scope interpretable from the technical ideas defined by the claims.

### REFERENCE SIGNS LIST

1 Preprocessing apparatus
2 Feed pump
3 Electric motor
4 High pressure pump
5 Reverse osmosis (RO) membrane separation apparatus
6 Freshwater
7 Highly pressurized condensed seawater
8 Energy recovery apparatus
9 Booster pump
12 Reduced voltage starter
13 Switching circuit
100 Power source
300 Power control circuit

1. A seawater desalination system for carrying out desalination of seawater to thereby produce freshwater from the seawater, the seawater desalination system comprising:
a high pressure pump adapted to raise pressure of the seawater to be desalinated;
a separation apparatus comprising an RO membrane adapted to separate the seawater provided from the high pressure pump, into freshwater having a low salt concentration and condensed seawater having a high salt concentration;
an electric motor adapted to drive the high pressure pump;
a start-up and shut-down adjusting device, coupled between the electric motor and an AC power source, adapted to continuously increase an AC voltage to be supplied to the electric motor during a start-up adjusting period of the electric motor, and continuously decrease the AC voltage to be supplied to the electric motor during a shut-down adjusting period of the electric motor; and
a switching circuit coupled in parallel with the start-up and shut-down adjusting device, adapted to be closed when the AC voltage to be supplied via the start-up and shut-down adjusting device to the electric motor is equal to the AC voltage outputted from the AC power source, to thereby supply the AC voltage outputted from the AC power source directly to the electric motor.

2. The seawater desalination system of claim 1, wherein the start-up and shut-down adjusting device is adapted to increase the AC voltage to be supplied to the electric motor in accordance with a monotonically increasing function having an upward convex shape but not a linear shape during the start-up adjusting period, and decreases the AC voltage to be supplied to the electric motor in accordance with a monotonically decreasing function having an upward convex shape but not a linear shape during the shut-down adjusting period.

3. The seawater desalination system of claim 2, wherein the monotonically increasing function having the upward convex shape gradually increases and approaches the AC voltage outputted from the AC power source, and the monotonically decreasing function having the upward convex shape gradually decreases and departs from the AC voltage of the AC power source.

4. The seawater desalination system of claim 1, wherein a time duration of each of the start-up shut-down adjusting periods is set to be equal to or longer than a time duration determined based on a regular operating pressure and the maximum rise gradient allowable per unit time those are required for the RO membrane of the separation apparatus, and equal to or shorter than the settable maximum time duration of the start-up and shut-down adjusting device.

5. The seawater desalination system of claim 1, further comprising:
a feed pump placed prior to the high pressure pump, adapted to supply the seawater to the high pressure pump;
a second electric motor adapted to drive the feed pump; and
a controller adapted to control the second electric motor, wherein the feed pump is controlled based on a flow rate and temperature of the freshwater obtained from the separation apparatus and the pressure of the seawater at an inlet of the separation apparatus, to adjust the flow rate of seawater drained from the feed pump so that the amount of freshwater to be obtained from the separation apparatus is stabilized.

6. The seawater desalination system of claim 5, further comprising:
an energy recovery apparatus adapted to draw seawater branched from the seawater discharged from the feed pump, and apply pressure to the drawn seawater to thereby increase its pressure by use of highly pressurized condensed seawater discharged from the separation apparatus, and discharge the pressurized seawater from the energy recovery apparatus;
an automatic valve adapted to adjust the flow rate of the seawater from the feed pump to the energy recovery apparatus, or the flow rate of the condensed seawater from the energy recovery apparatus to the outside; and
a second controller adapted to control an open degree of the automatic valve based on the flow rate of seawater from the feed pump to the energy recovery apparatus and the flow rate of seawater from the energy recovery apparatus to the separation apparatus, to thereby stabilize the flow rate of seawater from the energy recovery apparatus to the separation apparatus.

7. A seawater desalination system for carrying out desalination of seawater to thereby produce freshwater from the seawater, the seawater desalination system comprising:
a feed pump adapted to supply seawater to be desalinated;
a high pressure pump adapted to raise pressure of the seawater provided from the feed pump;
a separation apparatus comprising an RO membrane adapted to separating the seawater provided from the high pressure pump, into freshwater having a low salt concentration and condensed seawater having a high salt concentration;
a first and second electric motors adapted to drive the feed pump and the high pressure pump, respectively;
a first controller adapted to control the first electric motor to adjust a flow rate of seawater drained from the feed pump, based on a flow rate and temperature of the freshwater drained from the separation apparatus and pressure of the seawater at an inlet of the separation apparatus, to stabilize an amount of the freshwater drained from the separation apparatus.

8. The seawater desalination system of claim 7, further comprising:
an energy recovery apparatus adapted to draw a part of the seawater from the feed pump, apply pressure to the drawn seawater to increase its pressure by use of highly pressurized condensed seawater from the separation apparatus, and discharge the pressurized seawater;
an automatic valve adapted to adjust the flow rate of seawater from the feed pump to the energy recovery apparatus or the flow rate of condensed seawater from the energy recovery apparatus to the outside; and
a second controller adapted to control an open degree of the automatic valve based on the flow rate of the seawater from the feed pump to the energy recovery apparatus and the flow rate of the seawater from the energy recovery apparatus to the separation apparatus, to stabilize the amount of seawater supplied from the energy recovery apparatus to the separation apparatus.
